(19) United States
(12) Patent Application Publication
(10) Pub. No.: US 2006/0069587 A1
(43) Pub. Date: Mar. 30, 2006

(54) Retained publish/subscribe system

(76) Inventors: Andrew David James Banks, Romsey (GB); Daniel Noel Millwood, Southampton (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/228,735

(22) Filed: Sep. 16, 2005

(30) Foreign Application Priority Data
Sep. 18, 2004 (GB) 0420812.0

(51) Int. Cl. G06Q 99/00

(52) U.S. Cl. 705/1

(57) ABSTRACT

Publications are retained in a publish subscribe broker hierarchy. The hierarchy includes publishers publishing to publishing brokers and subscribers subscribing to receive publications from the publishing brokers. A subscriber subscribes to receive publications on at least one topic from at least a subset of publishing brokers in the hierarchy. The subscriber receives publications on subscribed topics from brokers within the subset and retains the most recent publication on each topic.

### BACKGROUND OF THE INVENTION

The invention relates to a publish subscribe system and more particularly to a retained publish subscribe system.

Publish/subscribe data processing systems have become popular in recent years as a way of distributing data messages (publications). Publishers are typically not concerned with where their publications are going, and subscribers are typically not interested in where the messages they receive have come from. Instead, a message broker typically assures the integrity of the message source, and manages the distribution of the message according to the valid subscriptions registered in the broker.

Publishers and subscribers may also interact with a network of brokers, each one of which propagates subscriptions and forwards publications to other brokers within the network. FIG. 1 illustrates a typical publish/subscribe data processing system according to the prior art. A message broker 15 has an input mechanism 20 which may be, for example, an input queue or a synchronous input node by which messages are input when they are sent by a publisher 5; 10 to the message broker. A published message is fetched from the input mechanism by a controller 40 and processed to determine, amongst other things, to which subscribers 60; 65; 70 the message should be sent.

Message topics typically provide the key to the delivery of messages (publications) between publishers and subscribers. The broker attempts to match a topic string on a published message with a list of clients who have subscribed to receive publications including that topic string. A matching engine 30 is provided in the message broker for this very purpose. When the subscriber registers, it must typically specify a means by which it wants to receive messages (which may be a queue or other input mechanism) and a definition of the types of messages that it is interested in. A subscriber can specify that it wishes to receive messages including a topic string such as “employee/salary” and any messages matching that topic string will be identified and forwarded on to the subscriber via an output mechanism 50. (Note, there may be more than one input and output mechanism to and from which messages are received and sent by the message broker.)

A broker typically deletes a publication when it has delivered that publication to all the interested (registered) subscribers. This type of processing is suitable for event information (e.g. a stock trade or a goal scored), but is not always suitable for a subscriber that registers subsequently and wishes to be informed of the latest state information (e.g. the current price of a stock). A broker can therefore take it upon itself to keep, for example, a copy of the last publication received on each topic. Each such copy is called a retained publication.

Such a copy can be sent to subsequent subscribers who register an interest in the topic relating to the retained publication. This means that new subscribers do not have to wait for information to be published again before they receive it. For example, a subscriber registering a subscription to a stock price would receive the latest price straightaway, without waiting for the stock price to change (and hence be re-published).

Thus the last publication on each topic in a retained publication system is typically retained by the message broker (publishing broker/node) to which those publications are published. This requires that all brokers manage (retain) publications received locally.

### BRIEF SUMMARY OF THE INVENTION

According to one aspect of the present invention, a method may retain publications in a publish subscribe broker hierarchy. The hierarchy comprises publishers publishing to publishing brokers and subscribers subscribing to receive publications from the publishing brokers. The method comprises subscribing to receive publications on at least one topic from at least a subset of publishing brokers in the hierarchy, receiving publications on subscribed topics from brokers within the subset, and retaining the most recent publication on each topic.

According to another aspect of the present invention, a system comprises a retained publication server for retaining publications in a publish subscribe broker hierarchy. The hierarchy comprises publishers publishing to publishing brokers and subscribers subscribing to receive publications from said publishing brokers. The system includes a subscriber component for subscribing to receive publications on at least one topic from at least a subset of publishing brokers in the hierarchy, a receiver component for receiving publications on subscribed topics from brokers within the subset, and a retainer component for retaining the most recent publication on each topic.

According to yet another aspect of the present invention, a computer program product for retaining publications in a publish subscribe broker hierarchy comprises a computer usable medium having computer useable program code embodied therein. The hierarchy includes publishers publishing to publishing brokers and subscribers subscribing to receive publications from said publishing brokers. The computer useable program code comprises computer usable program code configured to subscribe to receive publications on at least one topic from at least a subset of publishing brokers in the hierarchy, computer usable program code configured to receive publications on subscribed topics from brokers within the subset, and computer usable program code configured to retain the most recent publication on each topic.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 illustrates a publish/subscribe system in accordance with the prior art;

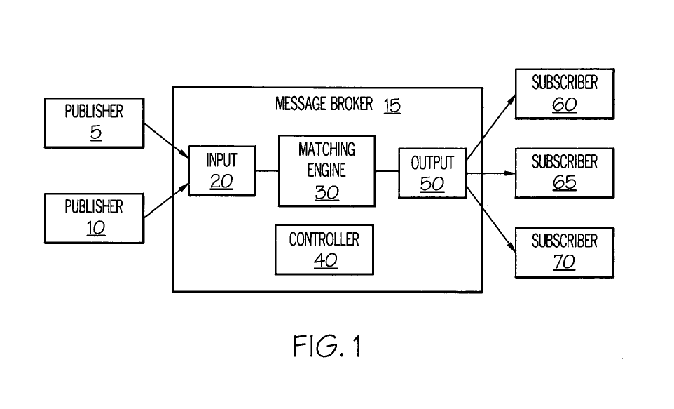

FIG. 2 shows a broker hierarchy in accordance with an embodiment of the present invention;

FIG. 3 illustrates a problem associated with the broker hierarchy;

FIG. 4 illustrates a solution to the problem illustrated by FIG. 3;

FIG. 5 shows a publishing broker in accordance with an embodiment of the present invention; and

FIG. 6 depicts an application of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-usable or computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

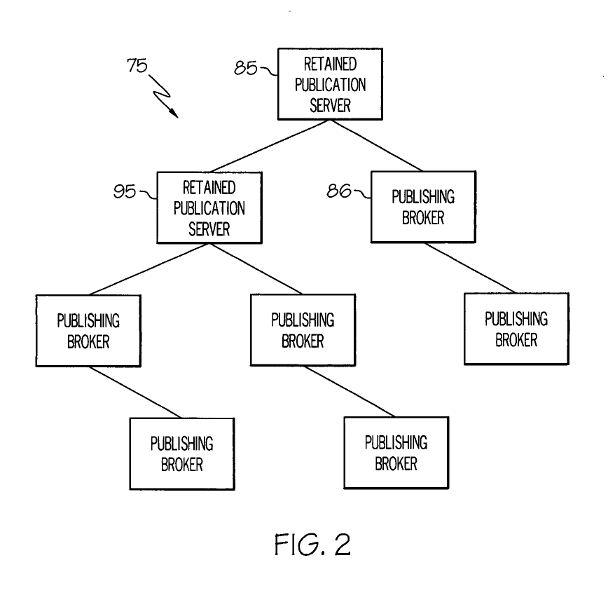

FIG. 2 shows a broker hierarchy 75 containing specialist retained publication servers 85, 95 in accordance with an embodiment of the present invention. These specialist retained publication servers are placed at strategic points throughout the broker hierarchy 75. An analysis may be undertaken to determine which nodes should become retained publication servers. The choice made can depend, for example, on the position of the node in the hierarchy (for example a central node generally means that the node is easily accessible to all other nodes in the hierarchy), the reliability and performance of the network connection to the node and the reliability of the node itself (for example a laptop is unlikely to make a good choice since it may not be permanently connected).

These specialist nodes retain the most recent publication on each topic. Whether a publication is most recent can depend on order of receipt at the broker or if there is the possibility that publications will overtake each other, a sequence number could be used.

By having only the designated specialist nodes retain publications, the administrative burden on the other publishing brokers is reduced (e.g. the task of backing up these brokers and ensuring availability of such brokers). Further it does not matter if a publishing broker goes offline—there may be one retained publication server in operation.

In order to be sure that a retained publication server receives all retained publications received within the broker hierarchy, the retained publication server may subscribe to at least those topics having messages which an administrator has determined should be retained (e.g. an administrator of the hierarchy may decide that all publications on topics a, b and c are to be retained). If this equates to all publications received, then each retained publication server makes a subscription request using the wildcard symbol. Such a subscription request is propagated throughout the hierarchy to all publishing brokers and is stored at each as subscription data (not shown). Note the retained publication server (an administrator thereof) may equally decide that retention of a subset of documents (as opposed to the complete set) is appropriate. In which case, the subscription request from the retained publication server will make reference to an appropriate set of topics.

A publisher typically publishes to its local publishing broker 86 which checks its subscription data in order to determine to which brokers a publication should be forwarded. Thus based on a retained publication server's earlier subscription request, all publications should reach such a server. Such publications may be categorized at the server by topic.

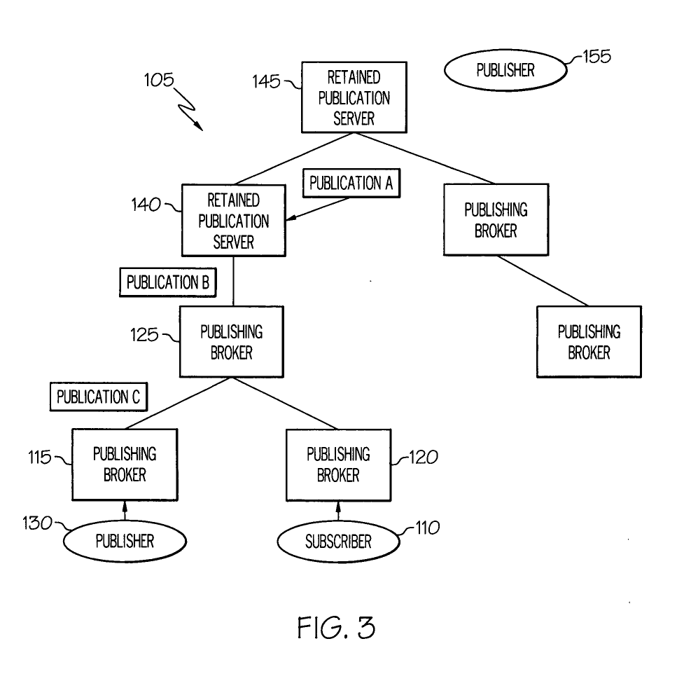

The use of specialist retained publication servers may be dedicated to retained publications. Referring now to FIG. 3, publisher 130 publishes publication A to broker hierarchy 105 and this is forwarded throughout the hierarchy to the publisher's most local retained publication server 140 (since 140 has a subscription to receive all publications published to the hierarchy 105). Publisher 130 again publishes to hierarchy 105 and its local publishing broker 115 propagates the publication (publication B) throughout the hierarchy. Publication B makes its way past publishing broker 125 and is in transit between that broker and the retained publication server 140.

Subscriber 110 then attaches to its local publishing broker 120 and makes a subscription request. Such a subscription request may indicate that the subscriber is after the latest retained publication and also any newly published information on the topic of IBM stock. This subscription is propagated throughout the hierarchy of publishing brokers 105.

The subscription is stored as subscription data (not shown) at each publishing broker. Consequently, subscription data relating to this request is held at publishing brokers 115, 120 and 125 (amongst others).

When the subscription request reaches retained server 140, it forwards on the its relevant retained publication. Thus subscriber 110 has received publication A (a retained publication) and believes that this is the last publication on the topic it has subscribed to. However, as mentioned above publication B was also previously published to the broker hierarchy 105. This publication had passed publishing broker 125 before subscriber 110's subscription request reached broker 125 and was in transit between publishing broker 125 and retained publication server 140 when the subscription request from subscriber 110 overtook the publication and reached retained publication server 140 first. This resulted in retained publication A being sent to subscriber 110 as the most recent retained publication (instead of publication B). Shortly afterwards, publication B reached the retained publication server 140 but naturally was not sent on to subscriber 110 because publication A had already been forwarded on. Further, since publication B had also passed publishing broker 125 before the subscriber's request got there, B also does not get sent to the subscriber as a current publication. Thus in such a situation, subscriber 110 does not receive publication B at all. Note, retained publication server also does not to send B to subscriber 110 as an ordinary publication because this would mean publishing back the route from which the publication originated (broker 125).

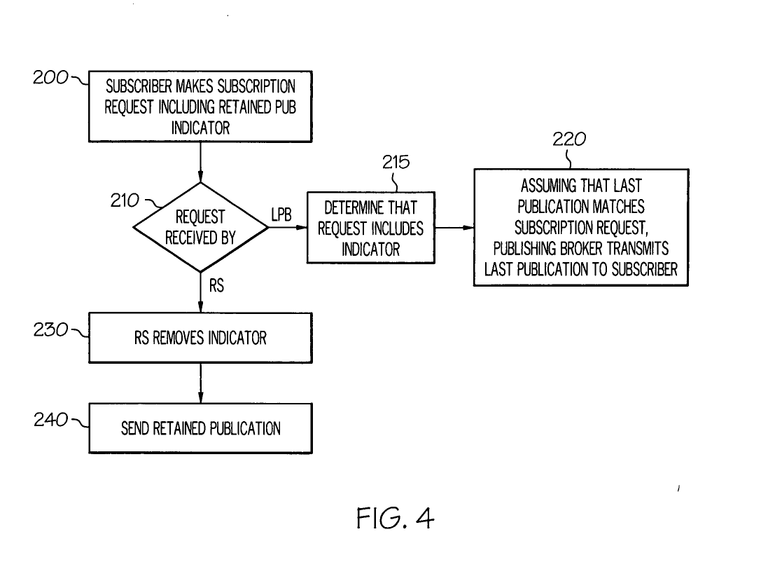

Referring now to FIG. 4, subscriber 110 makes a new subscription request at step 200. Such a subscription request is propagated to all publishing brokers below the most local retained publication server. In the example, this is brokers 125 and 115.

The subscription request includes a flag (indicator/bit) indicating that the latest (most recent) retained publication stored by retained publication server 140 on a topic matching the subscription request is desired. The request also indicates that any new publications are also desired and additionally indicates the source of the subscriber (i.e. a subscriber address). At step 210 it is determined who is the recipient of the subscription request. If the recipient is the most local retained publication server to the subscriber (RS), the RS removes the indicator from the request (if the request is being propagated up the hierarchy) (step 230) and sends the latest retained publication to the requesting subscriber (step 240). This retained publication may be sent directly to the requesting subscriber using the subscriber address contained within the request. The retained publication could be published to the entire hierarchy but this would result in the publication being re-seen by multiple publishing brokers. Another solution is to send the retained publication directly to the requesting subscriber. Note, the indicator can be removed because a retained publication server has already satisfied the subscriber's request—there is no need for another server at a different point in the hierarchy to do so (e.g. server 145). Further note, it may not be necessary to propagate a retained publication subscription request up the hierarchy once it has reached a first retained publication server. This is because for any publications reaching server 140 from higher up the hierarchy, the server acts as a regular broker.

If on the other hand a publishing broker below the most local retained publication server to the requesting subscriber (LPB) receives the request, the publishing broker determines that the request includes a retained publications indicator (step 215).

Each LPB retains the most recent publication published on each topic that was received from a local publisher (e.g. publisher 130 is local to broker 115). Note, this may not be in accordance with order of receipt and a sequence number may have to be used at the subscriber to determine the most recent publication on a topic.

There are a number of ways that an LPB could determine whether the publication has come from a local publisher (as opposed to a publishing broker). For example, the LPB could have a list of brokers that it expects to receive publications from—by implication if a publication has not come from one of these, it must instead have come from a local publisher. In some implementations, local publishers and publishing brokers make contact using a different publish verb.

Thus when a LPB receives a retained publication subscription, the LPB determines whether it has a stored copy of a publication which matches the subscription request and republishes this directly to the requesting subscriber (step 220). The publishing broker uses the subscriber address contained within the subscription request to determine to whom to republish. Alternatively, the publishing broker may republish its last publication to the entire broker hierarchy. Consequently, the publication is likely to get resent to subscribers who have already seen it.

Note, many pub/sub implementations do not enable a guarantee that the republished publication will not be overtaken by a subsequent publication and therefore arrive at a subscriber later than then new subsequent publication. This might be a problem if the receiving system is reliant upon the order in which publications are received. In this way it is possible to ensure that a publication is not missed in the way described with reference to FIG. 3.

Each broker is able to determine whether it is a publishing broker below the most local retained publication server. This is because once the subscription request has reached the most local retained publication server, the retained publication bit is removed. In any case, a retained publication subscription request may not be propagated any further once the local retained publication server has been reached. This is because the retained publication server has already subscribed to receive all publications relating to information that is to be retained. Thus there is no need to inform other brokers of the subscription request.

This issue does not occur when a subscription request and a publication are travelling in opposite directions through the hierarchy. For example if publisher 155 (FIG. 3) publishes directly to retained publication server 145 whilst subscriber 110 is subscribing via broker 120. Thus, removing the indicator from a subscription request which has reached retained publication server 140 is acceptable.

In order for either solution to work each publishing broker has to remember at least the most recent publication for each topic where such publications are received from local publishers. The publication is stored and forwarded as a single unit of work.

Note, it is not necessary for the retained publication server to do the republishing. This is because the retained publication server is not aware of what publications are in transit to the server. Thus, the retained publication server would not be able to easily deduce which publications to republish. However, the publishing brokers are all aware of the last publication that they published and consequently can republish appropriate publications.

Thus to take FIG. 3 as an example, subscriber 110 sends a subscription request with the retained publication bit set. By the time this request reaches local publishing broker 125, publication B has already passed through. There is the danger that the subscription request may then overtake publication B on the leg between broker 125 and 140. As explained above, this would result in subscriber 110 never seeing that publication. Note, although this is not shown in FIG. 3, whether such overtaking may happen is likely to be implementation and protocol specific. For example there may be a number of different routes from publishing broker 125 to retained publication server 140—one route may prove quicker than another.

In order to prevent this from happening, when broker 115 sees the subscription request including the set bit, the broker knows to re-publish its most recent publication on the topic matching the subscription request (i.e. publication B) directly to subscriber 110. In this way, subscriber 110 does not miss out on publication B. Note, subscriber 110 may end up seeing publication B more than once, but this is a tradeoff that is typically worthwhile.

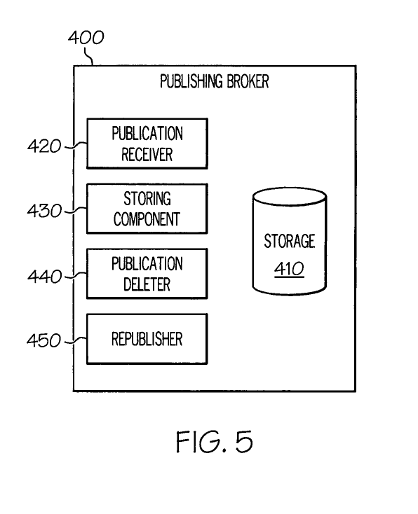

FIG. 5 illustrates a publishing broker in accordance with an embodiment of the present invention. Publishing broker 400 comprises a component 420 for receiving publications both from locally connected publishers and also from other publishing brokers. There is also a storing component 430 for storing the most recent publication on each topic (where that publication is received from a local publisher) in storage 410. A publication deleter 440 is responsible for overwriting a stored publication with a newly received publication. Finally a republishing component is responsible for inspecting a subscription request, determining that the retained publications bit is set, determining whether it has a copy of a most recently published publication and for republishing the stored publication relating to the particular topic requested directly to the requesting subscriber.

Note, previously if for example broker 125 had already subscribed to receive news/*, then a new subscription request of news/iraq would not have been propagated to server 140 since the previous subscription already encompasses this. However, the use of a retained publication bit ensures that all subscriptions are propagated to the retained publication server. Thus the more specific subscription is propagated in order to carry the retained publication bit.

It will be appreciated that in certain situations this solution will result in multiple copies of a publication being received at a subscriber. Software at each subscriber may remove redundant copies.

The position chosen for a retained publication server is desired since all publications now flow to this node. However, if a bad choice is made, this is likely to result in inefficient operation, but not incorrect operation.

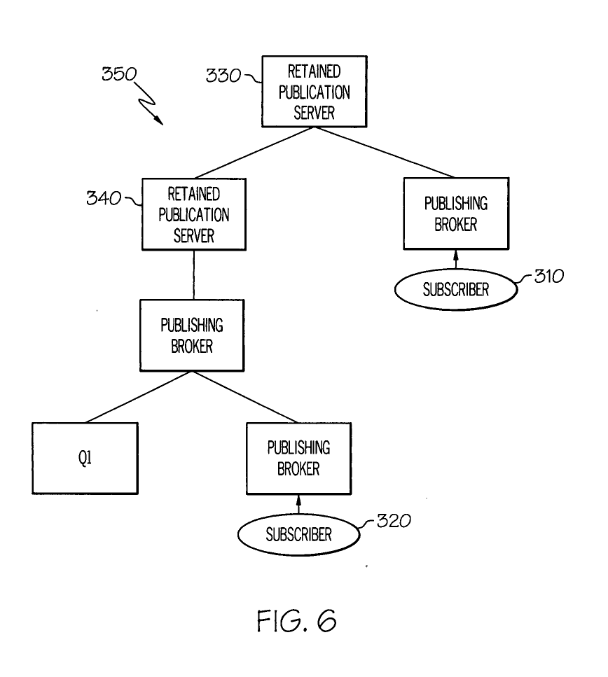

The solution described can be used to provide a naming service for locating a resource within a broker hierarchy. This will be explained using FIG. 6. Retained publication servers 330 and 340 subscribe to receive all publications in the hierarchy 350. (Note, an alternative is for the retained publication servers to subscribe to receive particular publications—e.g. those related to particular resources.) This subscription is then propagated throughout the hierarchy as is well known in the art. When queue 1 (Q1) is created on messaging engine 1 (ME1), this is published to the hierarchy and is received by the retained publication servers. Similarly, when a queue (e.g. Q2 on ME2) is deleted, this is also published to the hierarchy and retained by retained publication servers 330 and 340. The most recent publication relating to a particular resource is kept whilst older publications regarding the same resource can be deleted. Note, an ME comprises the functionality of a queue manager and also a message broker (i.e. includes a matching engine etc. for matching publication with appropriate subscribers.)

If a publication is received from the retained server and one is also received from a publishing broker where both publications are about the same resource, the nature of the publication is used to determine which publication is valid. E.g. a delete queue operation takes precedence over a create operation on the same queue. Alternatively, if this is not good enough then sequence numbers can be used.

An application may desire to send messages to a queue (e.g. Q1). It is first necessary to find out whether the queue exists and if so, where that queue is located. The application thus subscribes (subscriber 320) to receive all retained publications relating to Q1 (using a retained publication bit set in the subscription request). (An administrator of the broker hierarchy or of a particular messaging engine may be able to inform an application of the resource name.)

This is achieved using the subscription request Q1/* with the retained publication bit set. This subscription is propagated throughout the network and is received by the closest retained publication server—in this case 340. Retained publication server 340 is aware of the existence of Q1 since when Q1 was created, ME1 published this to the broker hierarchy. (This publication included the name of the resource and the name of the machine upon which it exists.)

The retained publication server thus checks its subscription data and sends any retained publication relating to Q1 to subscriber 320 (the retained publication server will have stored the last publication about queue 1).

Similarly when Q2 on ME2 is created, this is published to the broker hierarchy and this information is stored at retained publication servers 330 and 340. Subsequently, Q2 is deleted (x) and this is published to the broker hierarchy.

Subscriber 310 may subscribe to receive all publications relating to Q2 (Q2/*). In this way, subscriber 310 is kept informed as to the status of Q2.

Thus it should now be appreciated, that if a retained server is aware of the status of a resource (i.e. if the resource exists), then any subscribers to information on that resource will be updated as and when the status of the subscribed to resource changes.

Q3 does not exist and has never existed. Subscriber 310 however subscribes to receive information on Q3 (Q3/*). Because Q3 has never existed, the retained publication server has no knowledge of it. Consequently there are no publications matching the subscription data and so nothing on this topic is sent to subscriber 310. Alternatively the retained publication server could send confirmation that it has no knowledge of Q3.

Subscribers need to be sure that if a retained publication on a relevant topic (resource) exists, then they see that publication. In other words, they want to be sure whether a resource exists and if so, its status.

As explained above, in a system where a number of specialist nodes retain publications, there is the possibility that a relevant publication may not get sent to a subscriber—see FIG. 3 and the associated description.

The solution described with reference to FIG. 4 is used to prevent this from happening. Thus each publishing broker remembers (stores) the most recent publication on each resource where such information was received from a local publisher. When a publishing broker (or ME) receives a subscription request with a retained publication bit set, the broker republishes the stored publication matching the received subscription request. This publication may be sent directly to the source of the subscription request.

Note, whilst an administrator may be able to inform a subscriber of the name of a resource to subscribe to, other details may be hidden from the subscriber (i.e. not hard coded into a subscriber application). Instead, a subscriber submits its subscription request to a local publishing broker which propagates this throughout the hierarchy. Any information relating to a particular resource is published to the hierarchy and consequently reaches the subscriber which can act on this. In this way only initial contact with an administrator is required to learn the name of the resource to query.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is apparent to one skilled in the art that numerous modifications and departures from the specific embodiments described herein may be made without departing from the spirit and scope of the invention.

What is claimed is:

1. A method for retaining publications in a publish subscribe broker hierarchy, the hierarchy comprising publishers publishing to publishing brokers and subscribers subscribing to receive publications from said publishing brokers, the method comprising:
subscribing to receive publications on at least one topic from at least a subset of publishing brokers in the hierarchy;
receiving publications on subscribed topics from brokers within the subset; and
retaining the most recent publication on each topic.

2. The method of claim 1 further comprising:
receiving a subscription request from a subscriber;
determining that the subscription request indicates that the subscriber is interested in a retained publication on a particular topic;
sending the retained publication to the subscriber.

3. The method of claim 2 wherein sending the retained publication to the subscriber comprises:
forming a point-to-point connection with the subscriber; and
sending the retained publication to the subscriber via the point-to-point connection.

4. The method of claim 2 further comprising:
receiving at a local publishing broker publications;
determining which publications are from publishers local to the publishing broker;
storing the most recent publication on each topic where the publication is received from a local publisher;
propagating stored publications through the hierarchy;
receiving a subscription request from a subscriber which matches the previously stored and propagated publication;
determining whether the subscriber is interested in a retained publication;
republishing the stored publication to the subscriber in response to a positive determination; and
forwarding the subscription request onto the retained publication server.

5. The method of claim 4, wherein republishing the stored publication to the subscriber comprises:
forming a point-to-point connection with the subscriber; and
publishing via the point-to-point connection.

6. The method of claim 5, wherein republishing the stored publication to the subscriber further comprises:
extracting the location of the subscriber from the subscription request in order to form the point-to-point connection.

7. The method of claim 4, wherein republishing the stored publication to the subscriber comprises publishing to the broker hierarchy.

8. A system comprising:
a retained publication server for retaining publications in a publish subscribe broker hierarchy, wherein the hierarchy comprises publishers publishing to publishing brokers and subscribers subscribing to receive publications from said publishing brokers;
a subscriber component for subscribing to receive publications on at least one topic from at least a subset of publishing brokers in the hierarchy;
a receiver component for receiving publications on subscribed topics from brokers within the subset; and
a retainer component for retaining the most recent publication on each topic.

9. The system of claim 8 comprising:
a subscription receiver component for receiving a subscription request from a subscriber;
a determining component for determining that the subscription request indicates that the subscriber is interested in a retained publication on a particular topic;
a sending component for sending the retained publication to the subscriber.

10. The system of claim 9 wherein the sending component comprises a connection forming component for forming a point-to-point connection with the subscriber, and wherein the sending component is operable to send the retained publication to the subscriber via the point-to-point connection.

11. The system of claim 9 further comprising a publishing broker comprising:
a receiver component for receiving publications;
a determining component for determining which publications are from publishers local to the publishing broker;
a storing component for storing the most recent publication on each topic where the publications is received from a local publisher;
a propagating component for propagating stored publications through the hierarchy;
a subscription request receiving component, responsive to the propagating component, for receiving a subscription request from a subscriber which matches a previously stored and propagated publication;
a second determining component for determining whether the subscriber is interested in a retained publication;
a publishing component, responsive to a positive determination from the determining component, for republishing the previously stored publication to the subscriber; and
a forwarding component for forwarding the subscription request onto the retained publication server.

12. The system of claim 11, wherein the publishing component comprises a connection forming component for forming a point-to-point connection with the subscriber and publishing via the point-to-point connection.

13. The system of claim 12, wherein the publishing component comprises an extractor component for extracting the location of the subscriber from the subscription request in order to form the point-to-point connection.

14. The system of claim 11, wherein the publishing component comprises publishing to the broker hierarchy.

15. The system of claim 9, wherein the retained publication server is a resource advertising server, wherein the subscribing component is operable to subscribe to receive publications regarding the status of a plurality of resources, wherein the retainer component is operable to retain the most recent publication about each of the resources; wherein the subscription receiver component is operable to receive a subscription request from a subscriber about the status of one of the resources; and wherein the determining component is operable to determine that the subscription request indicates that the subscriber is interested in a retained publication about the resource.

16. A computer program product for retaining publications in a publish subscribe broker hierarchy, the hierarchy including publishers publishing to publishing brokers and subscribers subscribing to receive publications from said publishing brokers, the computer program product comprising:
a computer usable medium having computer useable program code embodied therein, the computer useable program code comprising:
computer usable program code configured to subscribe to receive publications on at least one topic from at least a subset of publishing brokers in the hierarchy;
computer usable program code configured to receive publications on subscribed topics from brokers within the subset; and
computer usable program code configured to retain the most recent publication on each topic.

17. The computer program product of claim 16 further comprising:
computer usable program code configured to receive publications;
computer usable program code configured to determine which publications are from publishers local to the publishing broker;
computer usable program code configured to store the most recent publication on each topic where the publication is received from a local publisher;
computer usable program code configured to propagate stored publications through the hierarchy;
computer usable program code configured to receiving a subscription request from a subscriber which matches the previously stored and propagated publication;
computer usable program code configured to determine whether the subscriber is interested in a retained publication;
computer usable program code configured to republishing the stored publication to the subscriber in response to a positive determination;
computer usable program code configured to forward the subscription request onto the retained publication server;
computer usable program code configured to receive the subscription request at the retained publication server;
computer usable program code configured to determine that the subscription request indicates that the subscriber is interested in a retained publication on a particular topic; and
computer usable program code configured to send the retained publication to the subscriber.

18. The computer program product of claim 17, wherein the retained publication server is a resource advertising server, wherein the computer usable program code configured to subscribe to receive publications on at least one topic from at least a subset of publishing brokers in the hierarchy comprises computer usable program code to receive publications regarding the status of a plurality of resources, wherein the computer usable program code configured to retain the most recent publication on each topic comprises computer usable program code to retain the most recent publication about each of the resources, wherein the computer program further comprises:
computer usable program code to receive a subscription request from a subscriber about the status of one of the resources;
computer usable program code to determine that the subscription request indicates that the subscriber is interested in a retained publication about the resource; and
computer usable program code to send the retained publication about the resource to the subscriber.
